(19) United States
(12) Patent Application Publication
(10) Pub. No.: US 2012/0261137 A1
(43) Pub. Date: Oct. 18, 2012

(54) FLOW CONTROL SYSTEM

(75) Inventors: Ricardo Martinez, Spring, TX (US); Dinesh Patel, Sugar Land, TX (US); Steven Anyan, Missouri City, TX (US); Tauna Leonardi, Pearland, TX (US); Seth Conaway, Houston, TX (US); Arlene Bhuiyan-Khan, Houston, TX (US)

(73) Assignee: SCHLUMBERGER TECHNOLOGY CORPORATION, Sugar Land, TX (US)

(21) Appl. No.: 13/428,248

(22) Filed: Mar. 23, 2012

Related U.S. Application Data
(60) Provisional application No. 61/470,257, filed on Mar. 31, 2011.
(60) Provisional application No. 61/470,277, filed on Mar. 31, 2011.
(60) Provisional application No. 61/470,291, filed on Mar. 31, 2011.
(60) Provisional application No. 61/481,819, filed on May 3, 2011.

(51) Int. Cl. E21B 34/06; F17D 1/00

(52) U.S. Cl. 166/373; 137/1; 166/316

(57) ABSTRACT

A technique facilitates controlling flow of fluid along a flow passage. A flow control assembly is placed along a flow passage, and a bypass is routed past the flow control assembly. Flow along the bypass is controlled by a flow bypass mechanism which may be operated via a pressure or other interventionless application. The pressure, or other interventionless application, is used to actuate the flow bypass mechanism so as to selectively allow flow through the bypass.

### CROSS-REFERENCE TO RELATED APPLICATION

The present document is based on and claims priority to U.S. Provisional Application Ser. No. 61/470,257, filed Mar. 31, 2011, U.S. Provisional Application Ser. No. 61/470,277, filed Mar. 31, 2011, U.S. Provisional Application Ser. No. 61/470,291, filed Mar. 31, 2011, and U.S. Provisional Application Ser. No. 61/481,819, filed May 3, 2011, incorporated herein by reference.

### BACKGROUND

Hydrocarbon fluids such as oil and natural gas are obtained from a subterranean geologic formation, referred to as reservoir, by drilling a well that penetrates the hydrocarbon-bearing formation. In a variety of downhole applications, flow control devices, e.g. in-line barrier valves, are used to control flow along the well system. Accidental or inadvertent closing or opening of in-line barrier valves can result in a variety of well system failures. In some applications, adverse formation issues may occur in a manner that initiates pumping of heavier fluid for killing of the reservoir. In such an event, the in-line barrier valve is opened to allow pumping of kill weight fluid.

### SUMMARY

In general, the present disclosure provides a system and method for controlling flow, e.g. controlling flow along a wellbore. A flow control assembly, e.g. an in-line barrier valve, is placed along a flow passage. A bypass is routed past the flow control assembly. Flow along the bypass is controlled via a flow bypass mechanism which may be operated interventionless by, for example, pressure, e.g. a pressure differential, pressure pulse, absolute pressure, or other suitable interventionless technique. The interventionless application of pressure or other type of signal is used to actuate the flow bypass mechanism to selectively allow flow through the bypass.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is an illustration of an embodiment of a well system having an in-line barrier valve, according to an embodiment of the disclosure;

FIG. 2 is a flowchart providing an example of operation of the well system illustrated in FIG. 1, according to an embodiment of the disclosure;

FIG. 3 is an illustration of another embodiment of a well system having an in-line barrier valve, according to an embodiment of the disclosure;

FIG. 4 is a flowchart providing an example of operation of the well system illustrated in FIG. 3, according to an embodiment of the disclosure;

FIG. 5 is an illustration of another embodiment of a well system having an in-line barrier valve, according to an embodiment of the disclosure;

FIG. 6 is a flowchart providing an example of a well depletion process, according to an embodiment of the disclosure;

FIG. 7 is an illustration of another embodiment of a well system, according to an embodiment of the disclosure;

FIG. 8 is an illustration similar to that of FIG. 7 but showing an added lubricator valve, according to an embodiment of the disclosure;

FIG. 9 is an illustration of another embodiment of a well system having an in-line barrier valve, according to an embodiment of the disclosure;

FIG. 10 is an illustration similar to FIG. 9 but showing additional features, according to an embodiment of the disclosure;

FIG. 11 is an illustration of another embodiment of a well system having an in-line barrier valve, according to an embodiment of the disclosure;

FIG. 12 is an illustration of another embodiment of a well system having an in-line barrier valve, according to an embodiment of the disclosure;

FIG. 13 is an illustration of another embodiment of a well system having an electric submersible pumping system, according to an embodiment of the disclosure;

FIG. 14 is an illustration of another embodiment of a well system having a plurality of electric submersible pumping systems, according to an embodiment of the disclosure;

FIG. 15 is an illustration of an embodiment of a diverter valve system for use with the well system illustrated in FIG. 13 or FIG. 14, according to an embodiment of the disclosure;

FIG. 16 is a schematic illustration of a multi-segment flapper valve that can be used with the diverter valve system, according to an embodiment of the disclosure;

FIG. 17 is an illustration similar to that of FIG. 15 but showing the diverter valve system in a different operational position, according to an embodiment of the disclosure;

FIG. 18 is an illustration similar to that of FIG. 15 but showing the diverter valve system in a different operational position, according to an embodiment of the disclosure;

FIG. 19 is an illustration of another embodiment of a diverter valve system for use with the well system illustrated in FIG. 13 or FIG. 14, according to an embodiment of the disclosure;

FIG. 20 is a schematic illustration of a multi-segment flapper valve that can be used with the diverter valve system illustrated in FIG. 19, according to an embodiment of the disclosure;

FIG. 21 is an illustration similar to that of FIG. 19 but showing the diverter valve system in a different operational position, according to an embodiment of the disclosure;

FIG. 22 is an illustration similar to that of FIG. 19 but showing the diverter valve system in a different operational position, according to an embodiment of the disclosure;

FIG. 23 is a schematic illustration of an embodiment of a diverter valve, according to an embodiment of the disclosure;

FIG. 24 is a cross-sectional view taken generally along line 24-24 of FIG. 23, according to an embodiment of the disclosure;

FIG. 25 is a cross-sectional view taken generally along line 25-25 of FIG. 23, according to an embodiment of the disclosure;

FIG. 26 is a schematic illustration of another embodiment of a diverter valve, according to an embodiment of the disclosure;

FIG. 27 is a cross-sectional view taken generally along line 27-27 of FIG. 26, according to an embodiment of the disclosure; and

FIG. 28 is a cross-sectional view taken generally along line 28-28 of FIG. 26, according to an embodiment of the disclosure.

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The disclosure herein generally involves a system and methodology related to controlling flow along a passage, such as a wellbore. A variety of in-line flow control devices may be controlled via various inputs from, for example, a surface location. Examples of in-line flow control devices include ball valves, flapper valves, sliding sleeves, disc valves, electric submersible pumping systems, other flow control devices, or various combinations of these devices. The system also may utilize a bypass positioned to route fluid flow around one or more of the in-line flow control devices during certain procedures. A variety of flow bypass mechanisms may be selectively controlled to block or enable flow through the bypass. Control over the in-line flow control devices and the flow bypass mechanisms facilitate a variety of operational and testing procedures.

The in-line flow control devices and the bypass systems may be used in many types of systems including well systems and non-well related systems. In some embodiments, the in-line flow Control device(s) is combined with a well system, such as a well completion system to control flow. For example, in-line flow control devices and bypass systems may be used in upper completions or other completion segments of a variety of well systems, as described in greater detail below.

According to an embodiment of the disclosure, a method is provided for isolating a tubing zone with a flapper mechanism or lubricator valve to enable testing of the tubing zone. The method further comprises the use of a flow bypass mechanism to selectively reveal a flow path circumventing the barrier. The mechanisms may be activated by various interventionless techniques, including use of pressure, e.g. pressure pulses, in the tubing string to overcome a differential pressure. The interventionless techniques also may comprise use of absolute pressure, pressure cycles of applying pressure followed by bleeding off pressure, wireless communication from the surface, e.g. electromagnetic or acoustic communication, or other suitable interventionless techniques.

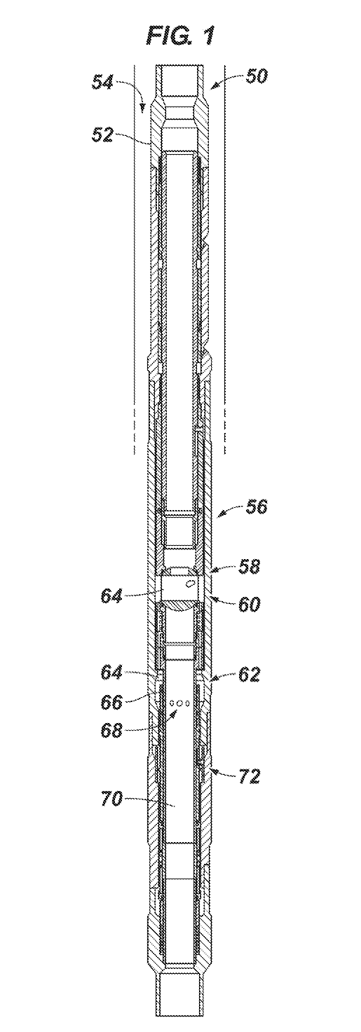

Referring generally to FIG. 1 a flow control system is illustrated as comprising a well system. The well system can be used in a variety of well applications, including onshore applications and offshore applications. In this example, a flow control system 50 comprises or is formed within a well system 52 deployed in a wellbore 54. The flow control system 50 comprises a variety of components for controlling flow through the well system 52.

In the example illustrated, well system 52 comprises a lubricator valve system 56 that is hydraulically controlled from the surface. The lubricator valve system 56 utilizes an in-line barrier valve 58 having a primary barrier which may be in the form of a ball valve 60. The ball valve 60 is suitably rated for high-pressure tubing zone testing that can be performed to validate uphole equipment. The primary barrier valve, e.g. ball valve 60, can be actuated numerous times as desired for testing or other procedures. Also, the ball valve 60 may be designed as a bidirectional ball valve that can seal in either direction.

In The example illustrated, the well system 52 further comprises a flow bypass mechanism 62 which maybe selectively moved between a blocking position and an open flow position. The flow bypass mechanism is used to selectively block or enable flow along a bypass 64 which, when opened, allows fluid to bypass the in-line barrier valve 58. In the example illustrated, bypass 64 routes fluid past ball valve 60 even when ball valve 60 is in a closed position, as illustrated in FIG. 1. In some embodiments, bypass 64 may be routed, in part, along a passage through the ball valve 60, as illustrated, or around the ball valve 60, as described in greater detail below.

The flow bypass mechanism 62 may comprise a port blocking member 66 which is positioned to selectively block or allow flow through corresponding ports 68. Port blocking member 66 may be in the form of a sliding sleeve or other suitable member designed to selectively prevent or enable flow through the corresponding ports 68. When the port blocking members 66 is moved to expose ports 68, the ports 68 allow fluid flow between an internal primary flow passage 70 and bypass 64 to enable fluid to flow past the closed ball valve 60. In the embodiment illustrated, port blocking member 66 is coupled with an actuator 72, e.g. an indexer, which may be actuated by a suitable pressure application to move port blocking member 66 from the position blocking ports 68. The indexer 72 may comprise a J-slot indexer or another suitable type of indexer which reacts to pressure, e.g. a series of pressure pulses, increasing and bleeding off of pressure, absolute pressure, or other interventionless signals delivered downhole to actuate the indexer 72 and to thus move port blocking member 66. Depending on the application, pressure may be delivered to the indexer 72 through the well system tubing, through a control line, or through other passages directed along or through well system 52. In another embodiment, the illustrated indexer mechanism may be replaced with other types of actuators, such as smart actuators controlled and powered by suitable electronics and batteries to control the flow bypass. It should be noted that actuator 72 also can be an electrical actuator, a different type of hydraulic actuator, a mechanical actuator, or another type of suitable actuator.

In an operational example, if the well is to be killed and the primary barrier has failed in the closed position (e.g. ball valve 60 has failed in the closed position) a pressure actuation cycle is applied to the tubing of well system 52 above ball valve 60 to cycle indexer 72. After moving through the appropriate cycle, the indexer 72 translates port blocking member 66 away from ports 68 and locks in an open position, e.g. by locking the port blocking member 66. This movement of port blocking member 66 creates a flow path through ports 68 and the bypass 64. The pressure differentials applied to operate indexer 72 are independent from the control line or other flow passage through which pressure is delivered to actuate the barrier valve. Also, flow can be directed through the bypass 64 regardless of the failure state of the ball valve 60. For example, flow can be routed through bypass 64 even if valve 60 remains functional.

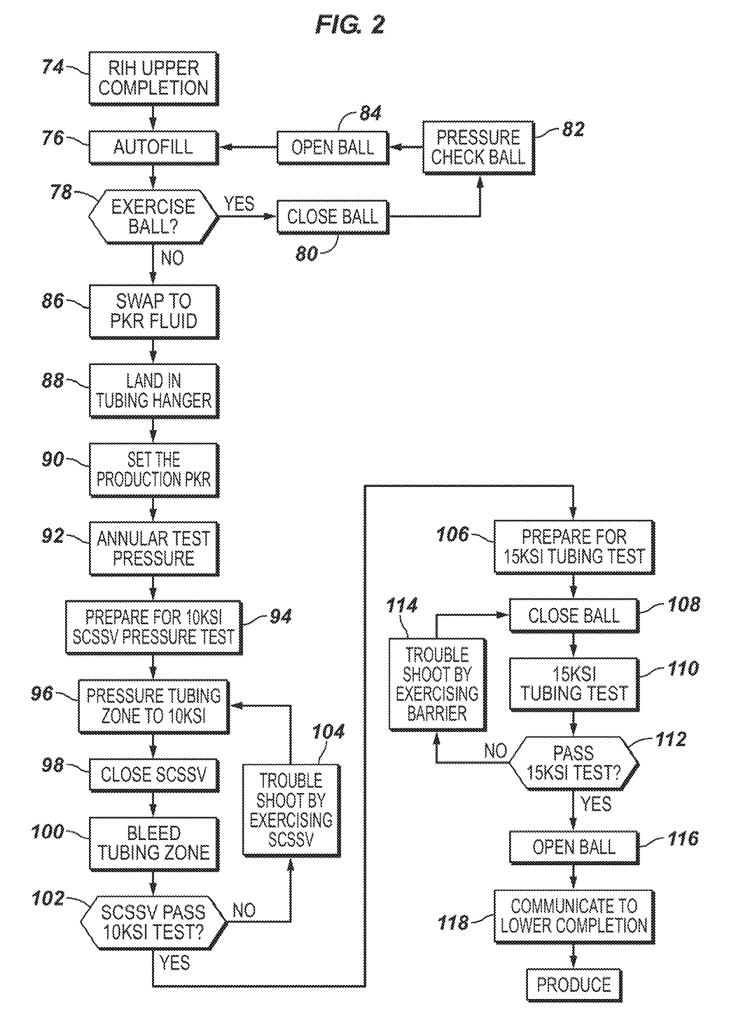

A more detailed operational example of an overall well testing procedure utilizing well system 52 is provided in the flowchart of FIG. 2. In this example, an upper completion (which may comprise well system 52) is initially run in hole, as indicated by block 74, and an auto fill function is performed, as indicated by block 76. A determination is made as to whether ball valve 60 is exercised, as indicated by block 78. If the ball valve 60 is open, the valve is then initially closed, as indicated by block 80, so that a pressure check may be performed on the ball valve 60 as indicated by block 82. Following the pressure check, the ball is opened as indicated by block 84, and auto filling can continue.

At decision block 78, if the ball valve does not need to be exercised, a swap is made to packer fluid, as indicated by block 86, and the well string is landed in a tubing hanger, as indicated by block 88. The production packer may then be set, as indicated by block 90, and an annular pressure test may be performed as indicated by block 92. The system is then prepared for a surface controlled subsurface safety valve pressure test, as indicated by block 94. The test is performed by initially applying pressure to the tubing, as indicated by block 96, and then closing the surface controlled subsurface safety valve, as indicated by block 98. The tubing zone at well system 52 may then be bled, as indicated by block 100, and the subsurface safety valve is tested to determine whether the pressure test has been successful, as indicated by decision block 102. If the subsurface safety valve has failed the pressure test, troubleshooting is performed by exercising the surface controlled subsurface safety valve, as indicated by block 104. If, however, the pressure test is successful, the system is prepared for a higher pressure test, as indicated by block 106.

To perform the higher pressure test, ball valve 60 is initially closed, as indicated by block 108. The higher pressure is delivered down through the tubing, as indicated by block 110, and the test results are evaluated as indicated by decision block 112. If the system fails the higher pressure tubing test, troubleshooting may be performed by exercising the in-line barrier valve system 58, e.g. ball valve 60, as indicated by block 114. Once the higher pressure testing is successful, ball valve 60 may be opened, as indicated by block 116, and communication to the lower completion is opened, as indicated by block 118. However, the flow bypass mechanism 62 and bypass 64 are available to circumvent the barrier valve 58/ball valve 60 if the ball valve 60 becomes stuck in the closed position or if flow through bypass 64 is desired for another reason.

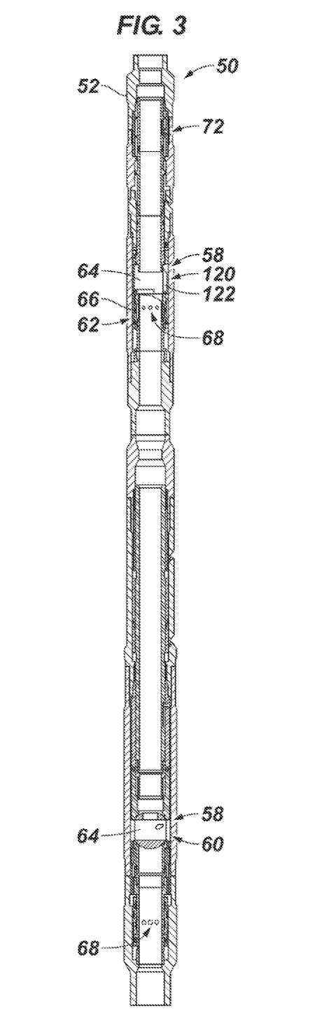

Referring generally to FIG. 3, another example of well system 52 is illustrated. In this example, well system 52 again comprises lubricator valve system 56 that is hydraulically controlled from the surface. The lubricator valve system 56 utilizes the in-line barrier valve system 58 having a primary barrier which may be in the form of the ball valve 60. The ball valve 60 is suitably rated to a pressure higher than the pressure rating of the equipment below the lubricator valve system 56. The primary barrier valve, e.g. ball valve 60, can be actuated numerous times as desired for testing or other procedures. However, the valve system 56 also comprises a secondary barrier valve 120 which may be in the form of a flapper valve 122 to facilitate performance of tubing zone tests to validate uphole equipment. The closed flapper valve 122 is suitably pressure rated for operation with the equipment above the lubricator valve system 56.

The flapper valve 122 may be activated by various techniques. In the illustrated example, the flapper valve 122 is activated by pressure pulses in the tubing string to overcome a dedicated hydraulic pressure from a control line or from an atmospheric chamber. After a tubing pressure test is conducted, a suitable pressure signal, e.g. a plurality of pressure pulses, may be applied to actuate a cycling mechanism, e.g. indexer 72, to provide a flow path (equalizing communication) between locations above and below the flapper valve 122 along bypass 64. As described above, the indexer 72 may be coupled with port blocking member 66 to selectively move port blocking member 66 so as to allow flow through ports 68. In this example, the indexer 72 may be used to ultimately translate the flapper valve 122 in a desired direction to permanently open the flapper barrier. As discussed above, indexer 72 may be in the form of other types of actuators which can be actuated electrically, hydraulically, mechanically and/or by other suitable techniques.

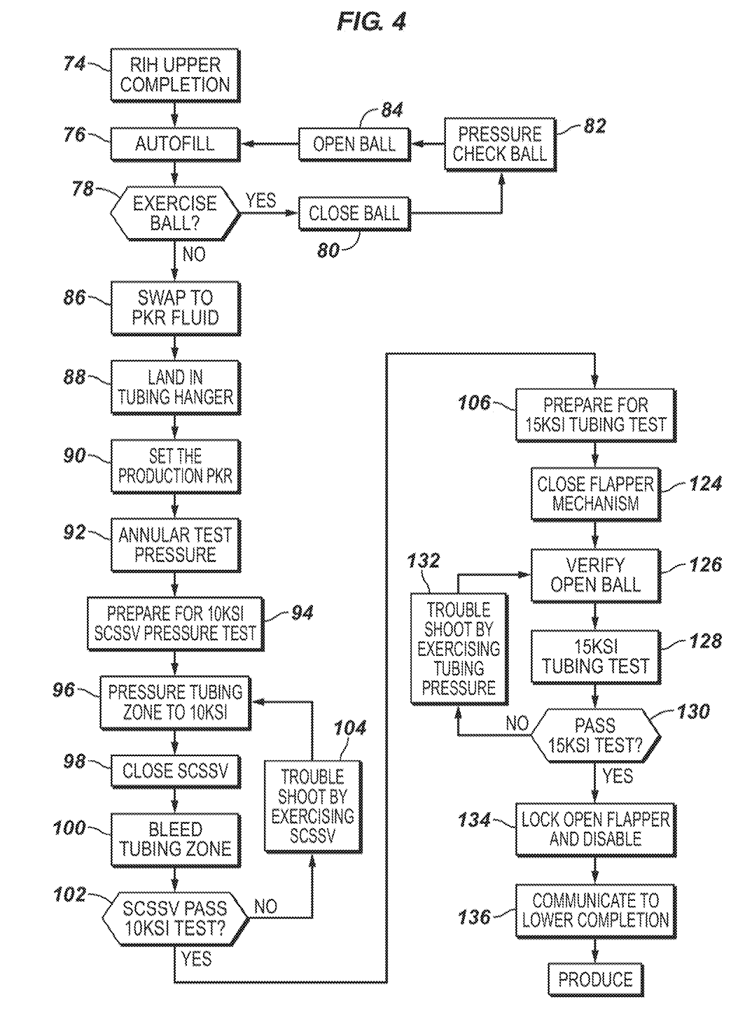

A detailed operational example of an overall well testing procedure utilizing well system 52 is provided in the flowchart of FIG. 4. In this example, many of the test elements correspond with test elements in the example illustrated in FIG. 2, and those elements have been labeled with corresponding reference numerals. In the example illustrated in FIG. 4, however, the flapper valve 122 is closed, as indicated by block 124, after preparing for the higher pressure tubing test indicated by block 106. After closing the flapper valve 122, ball valve 60 is verified as open, as indicated by block 126. The higher pressure tubing test is then performed, as indicated by block 128. If the tubing test fails, (see block 130) troubleshooting is performed by exercising tubing pressure, as indicated by block 132. However, if the higher pressure tubing test is successful, the flapper valve 122 is locked open via indexer 72 and disabled, as indicated by block 134. This action allows Communication with a lower completion to be enabled, as indicated by block 136.

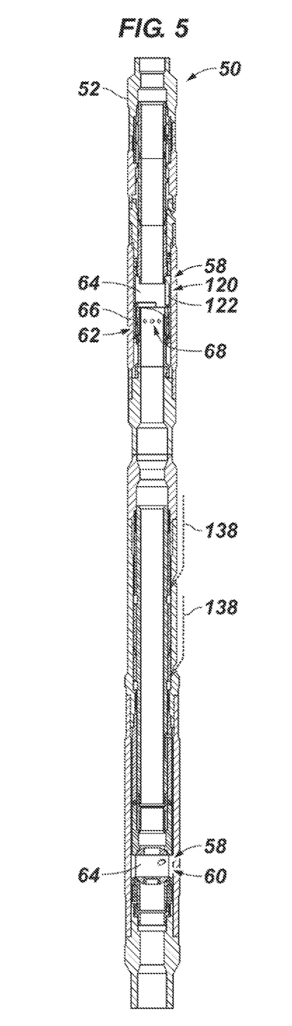

In FIG. 5, another embodiment is illustrated which is very similar to the embodiment illustrated in FIG. 3. The embodiment of FIG. 5 illustrates lubricator valve system 56 activated by two dedicated control lines 138. The dedicated control lines 138 may be in the form of hydraulic lines extending downhole from a surface location. In this example, the operational flowchart illustrated in FIG. 4 provides a suitable testing procedure.

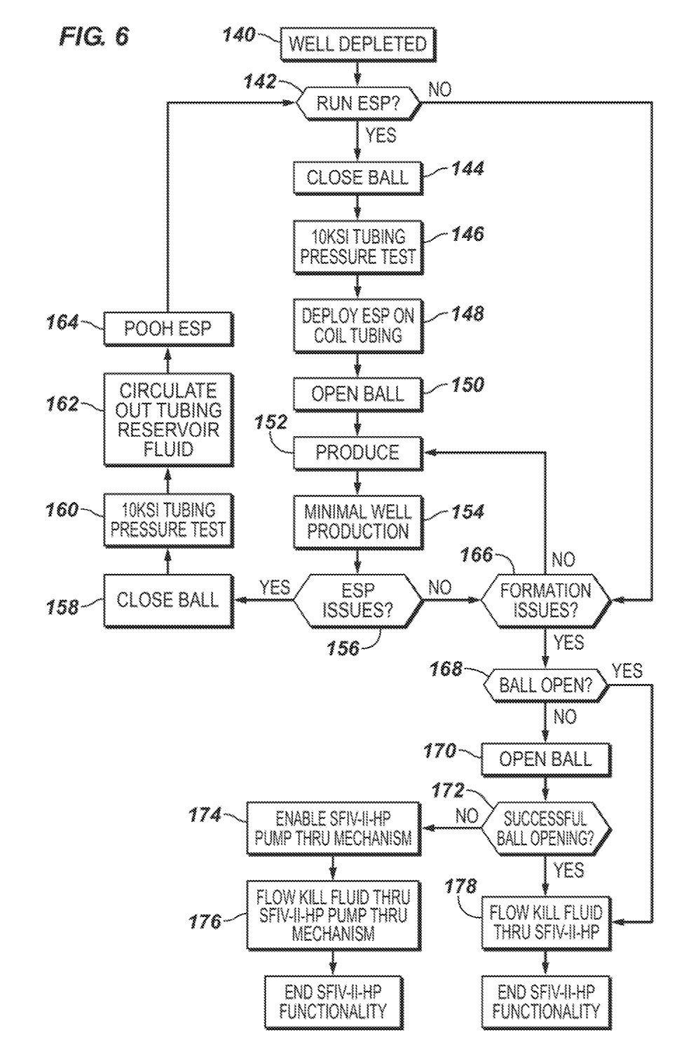

Referring generally to the flowchart of FIG. 6, another operational example is provided of a well completion process utilizing the lubricator valve system 56. In this example, a well completion process is initiated, as indicated by block 140, and a determination is made regarding running an electric submersible pumping system, as indicated by decision block 142. If the electric submersible pumping system is run, ball valve 60 is closed, as indicated by block 144. A tubing pressure test is performed, as indicated by block. 146, and the electric submersible pumping system is deployed on coiled tubing, as indicated by block 148. Ball valve 60 is then opened, as indicated by block 150, and the well is produced, as indicated by block 152.

Following minimal well production (see block 154), an evaluation is made as to whether issues exist with respect to the electric submersible pumping system, as indicated by decision block 156. If issues arise, ball valve 60 is closed, as indicated by block 158, and an additional pressure test is performed, as indicated by block 160. Tubing reservoir fluid is then circulated out, as indicated by block 162, and the electric submersible pumping system is pulled out of hole, as indicated by block 164, before rerunning the electric submersible pumping system (see block 142).

If there are no electric submersible pumping system issues to be addressed (see block 156) or if the electric submersible pumping system need not be run (see block 142), then formation issues are evaluated, as indicated by decision block 166. If no formation issues exist, the well can be produced (see block 152). When formation issues arise, however, an initial determination is made as to whether ball valve 60 is open, as indicated by decision block 168. If not open, the ball valve 60 is shifted to an open position, as indicated by block 170, and a determination is made as to whether the ball valve has been successfully opened, as indicated by decision block 172. When the ball valve cannot be successfully opened, the flow bypass mechanism 62 is actuated to open bypass 64, as indicated by block 174. This allows kill fluid to be pumped through bypass 64, as indicated by block 176. However, if the ball valve 60 is successfully opened, then kill fluid can be flowed downhole through the ball valve, as indicated by block 178.

The flow bypass mechanism 62 and bypass 64 enhance the flexibility of the system in a variety of testing and operational procedures. For example, if equipment above the lubricator valve system 56 is to be replaced, the ball valve 60 can be closed to allow for safe removal of the uphole equipment. If the well is to be killed, the primary barrier, e.g. ball valve 60, can be opened to communicate kill fluid to the formation. If, however, the well is to be killed and the primary barrier has failed in the closed position, the flow bypass mechanism 62 may be actuated by suitable techniques, such as application of a pressure signal along the tubing string to an indexer. The pressure actuations are independent of the control line pressures used to exercise ball valve 60 or other barrier valves in well system 52. With respect to the embodiments described above, the embodiment illustrated in FIG. 1 employs indexer 72 to move port blocking member 66 so as to allow kill fluid to flow through bypass 64. In the embodiment illustrated in FIG. 3, a pre-set restraint mechanism, e.g. port blocking mechanism 66, is moved to reveal a flow path which allows communication of kill fluid past the barrier and to the formation. In this example, bypasses may be used around one or both of the primary barrier valve 60 and the secondary barrier valve 120. In the embodiment illustrated in FIG. 5, a pre-set shear mechanism may be incorporated to reveal a flow path along bypass 64, as described in greater detail below.

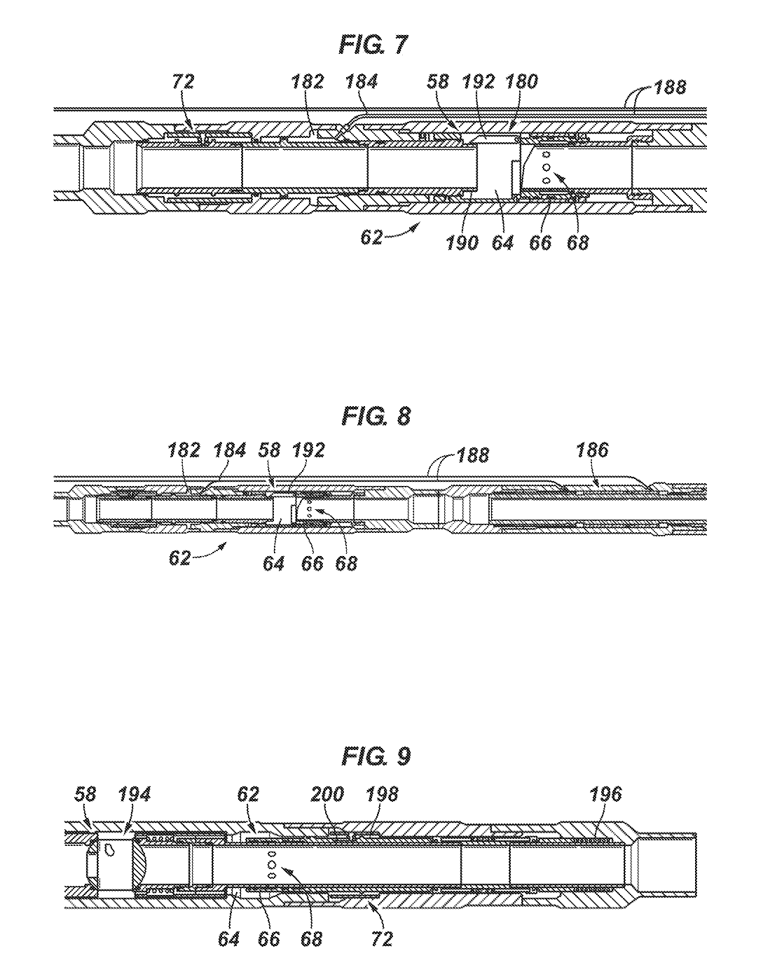

Referring generally to FIGS. 7 and 8, a more detailed example of one type of barrier valve 58 is illustrated. In this example, an in-line valve in the form of a flapper valve 180 is added to the lubricator/isolation valve system 56 and may be activated by various techniques, such as application of pressure pulses through the tubing string to overcome a dedicated hydraulic pressure from a control line or from an atmospheric chamber 182. Similar to the embodiment illustrated in FIG. 3, the flapper valve 180 may be controlled by indexer 72.

A dedicated control line 184 is routed to an existing hydraulic control line activated lubricator valve 186 positioned below the flapper valve 180, as best illustrated in FIG. 8. In this example, one of the control lines 188 for the lubricator valve 186 can be shut in to prevent inadvertent actuations of the lubricator valve 186. A differential pressure pulse or pulses is again used to actuate the cycling mechanism, e.g. indexer 72. By way of example, the cycling mechanism 72 may comprise a J-slot indexer designed so that tubing pressure translates the indexer against the hydrostatic head of the dedicated control line 184 to displace fluid in the control line. The tubing pressure is bled and pressure is again applied to the dedicated control line 184 at the surface to cycle the indexer 72. After a preset number of pressure applications, the indexer 72 translates a restraint 190 (initially used to keep a flapper 192 of the flapper valve 180 in an open position) to allow the flapper valve 180 to close. By way of example, the restraint 190 may comprise a flow tube attached to a mandrel of the indexer 72 or to a similar device. The closed flapper valve 180 provides a tubing pressure barrier which allows pressure validations of the uphole equipment. Continued pressure pulses actuate the indexer 72 to a preset J-slot which allows the indexer 72 to move port blocking member 66 and to open bypass 64 so as to provide equalizing communication between regions above and below the flapper valve 180. Ultimately, the indexer 72 may translate the flapper valve 180 in a downhole direction to a position which permanently opens the flapper valve.

In other embodiments, the flow bypass mechanism 62 may be added to other types of in-line barrier/isolation valves and may again be activated by a variety of techniques, including application of a pressure pulse or pulses in the tubing string in the embodiment illustrated in FIG. 9, for example, a more detailed example of one type of barrier valve 58 is illustrated. In this example, an in-line barrier valve in the form of a ball valve 194 is added to the lubricator/isolation valve system 56 and may be activated by various techniques, e.g. application of pressure through a control line. Similar to the embodiment illustrated in FIG. 1, port blocking member 66 may be translated by indexer 72. The indexer 72 may be biased against pressure applications through the tubing string by a spring 196. By way of example, the indexer 72 may again comprise a J-slot indexer having a mandrel 198 which is biased by spring 196 and cooperates with J-slots 200. Application of pressure in the tubing above the ball valve 194 moves mandrel 198 in a first direction and release of pressure allows the spring 196 to return the mandrel, thus cycling the indexer 72 through its indexer positions. At a specific cycle count, the mandrel 198 is shifted along a longer J-slot which allows the mandrel 198 to shift port blocking member 66 away from ports 68 to open a flow path along bypass 64. As described above, bypass 64 circumvents the barrier valve, e.g. ball valve 194. The indexer cycling method can initially be activated by a high pressure pulse or by a higher preset pressure pulse designed to overcome a restraint mechanism. Examples of restraint mechanisms can include shear mechanisms, e.g. shear pins or shear rings, a stiff collet, a strong return spring, or other restraint mechanisms. In some embodiments, the restraint mechanism can be used to disable the indexer and to maintain the flow path along bypass 64.

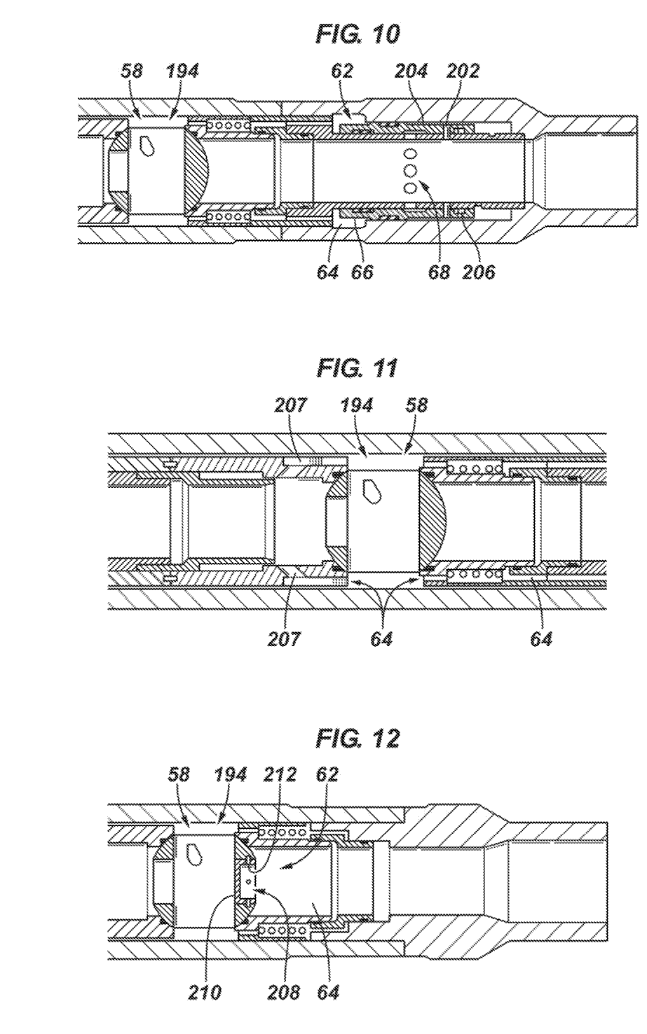

In FIG. 10, for example, a retention mechanism 202 is used in combination with a piston 204 to provide for use of a one-time pressure actuation which moves port blocking member 66 away from ports 68 to open the bypass 64. The one-time application of high pressure overcomes the preset shear force of the retention mechanism 202 and opens the flow path through ports 68 to allow communication across the barrier, e.g. around ball valve 194 (the fractured retention mechanism 202 allows movement of port blocking member 66 to uncover ports 68). By way of example, the retention mechanism 202 may comprise a shear pin, a shear ring, a stiff collet, or another suitable retention mechanism. A locking mechanism 206 may be used to lock the port blocking member 66 in an open position. By way of example, locking mechanism 206 may comprise a snap ring, a pin tumbler, or a similar device.

Another embodiment is illustrated in FIG. 11 in which the bypass 64 is not routed through the ball of ball valve 194. In this example, the bypass 64 includes an extended bypass portion 207 which routes fluid flow around the ball of the ball valve 194. This type of bypass 64 may be incorporated into the various embodiments described herein. In some applications, the extended bypass portion 207 may be employed to keep debris away from the ball valve 194 and to limit accumulation along the inside diameter of the ball.

Another embodiment is illustrated in FIG. 12 in which a one-time pressure actuation may again be used to open the system to fluid flow through bypass 64. In this example, a shearable mechanism 208 is incorporated into the ball valve 194. By way of example, shearable mechanism 208 may comprise a plug 210 retained in ball valve 194 by shear features 212, e.g. shear pins, shearable threads, a shearable, e.g. ceramic, disk, a disk retained by welding or brazing, or another suitable shear mechanism. Application of a differential pressure above the barrier established by ball valve 194 is used to overcome the preset shearable mechanism 208 to reveal a flow path along bypass 64 and directly through ball valve 194. However, other mechanisms may be used to remove plug 210. For example, application of a shear/removal force may be provided via coiled tubing, a drop bar or ball, a slickline tool, or another type of suitable tool. In the embodiment of FIG. 12, no additional locking mechanism is provided because the flow path is established through the hole created in the primary in-line. barrier, e.g. ball valve 194.

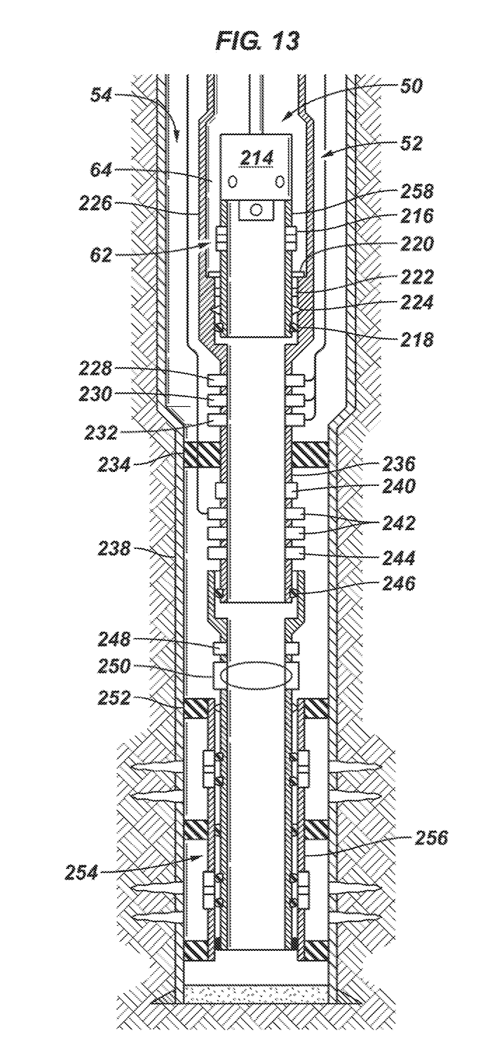

In another embodiment, the well system 52 comprises an electric submersible pumping system 214 run in hole and used in cooperation with a flow diverter valve 216, as illustrated in FIG. 13. By way of example, the flow diverter valve 216 may comprise a plurality of flow diverter valves positioned below or above the electric submersible pumping system 214. In FIG. 13, the flow diverter valves 216 are illustrated below or farther downhole relative to the electric submersible pumping system 214, however other embodiments may use flow diverter valves 216 positioned above or farther uphole relative to the electric submersible pumping system 214. For example, certain embodiments may employ electric submersible pumping system 214 to inject fluid down into the well. The flow diverter valves 216 may be used in combination with electric submersible pumping system 214 in a variety of well systems 52 and the embodiment illustrated in FIG. 13 is provided as an example.

Referring again to the example of FIG. 13, well system 52 may comprise many types of features below electric submersible pumping system 214 and flow diverter valve 216. By way of example, the system may comprise a polished bore receptacle and seal assembly 218 combined with a debris protector 220, an anti-torque lock 222, and a latch 224 positioned within a flow shroud 226 arranged around the electric submersible pumping system 214. Other features may comprise a lubricator valve 228, a circulating valve 230, and a surface controlled subsurface safety valve 232 positioned above a production packer 234. In this embodiment, production tubing 236 extends down from production packer 234 within a casing 238. A variety of features may be located beneath production packer 234, such as a rupture disc sub 240, a chemical injection mandrel 242, and a pressure/temperature gauge mandrel 244.

Beneath mandrel 244, another polished bore receptacle and seal assembly 246 may be used in combination with a nipple 248, a formation isolation valve 250, and an upper GP packer 252. In this example, a frac pack assembly 254 is positioned below upper GP packer 252. A production isolation seal assembly 256 also may be employed for isolating frac sleeves. However, many other types of features and components may be used in the well system depending on the specifics of a given application.

Regardless of the specific components of the well system 52, the flow diverter valve 216 may be positioned to allow free flow of fluid from inside a tubing 258 to an exterior of the tubing 258 when the electric submersible pumping system 214 is off. The flow diverter valve 216 may be designed so that pressure on the outside of the tool, e.g. on the outside of tubing 258, sufficiently increases when the electric submersible pumping system 214 is operating to automatically restrict flow through the flow diverter valves 216. However, when the electric submersible pumping system 214 is turned off, the flow diverter valves 216 again automatically open. In many applications, the flow diverter valves 216 serve to increase the life of the electric submersible pumping system and to reduce the workover frequency by automatically diverting flow along bypass 64 around the electric submersible pumping system 214 when the electric submersible pumping system is not operating. The flow is returned to the electric submersible pumping system 214 automatically when the system is running.

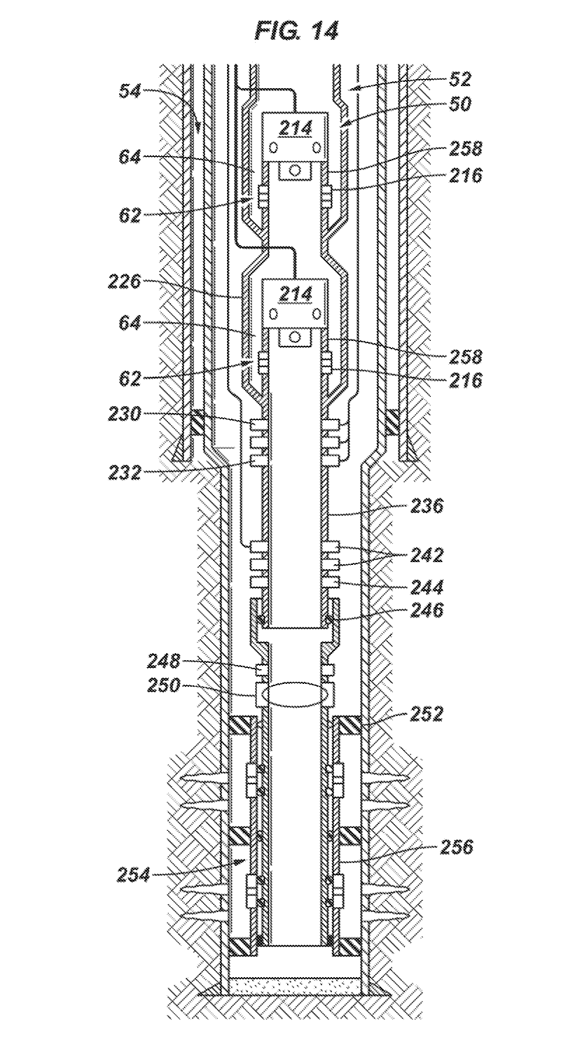

Referring generally to FIG. 14, another embodiment of a well system 52 is illustrated in which a pair of electric submersible pumping systems 214 is provided. In this example, flow diverter valves 216 are placed beneath each electric submersible pumping system 214. As illustrated, the upper set of flow diverter valves 216 is positioned between the electric submersible pumping systems 214.

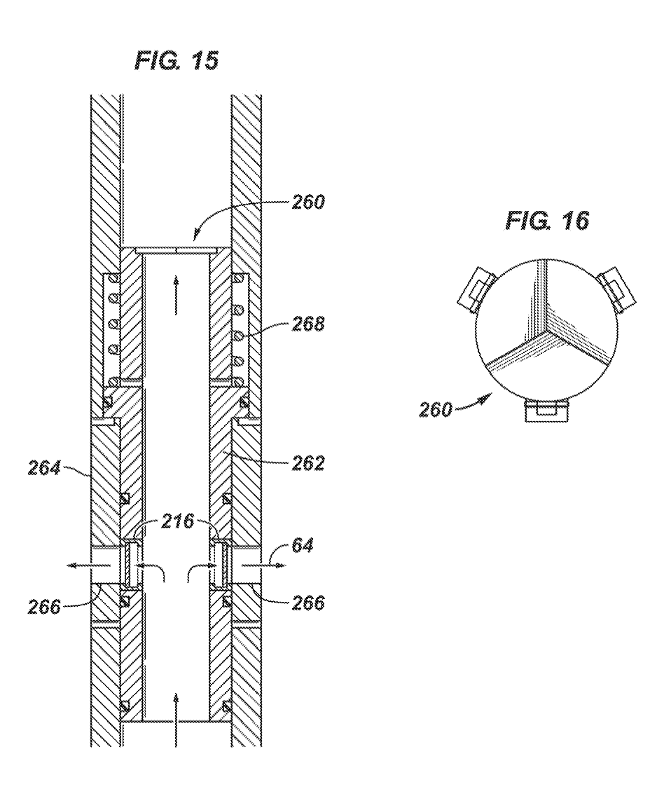

In FIGS. 15-18, an embodiment is illustrated in which flow diverter valves 216 are combined with a flapper type flow restrictor 260, such as a segmented flapper type flow restrictor located above the flow diverter valves 216. In this embodiment, the components are designed such that the pressure drop across the flapper type flow restrictor 260 is greater than the pressure drop across the flow diverter valves 216 so that flow may be diverted through the flow diverter valves 216 to bypass the electric submersible pumping system 214. The flapper type flow restrictor 260 opens automatically when the electric submersible pumping system 214 is turned on, and the flow diverter valves 216 are closed via the change in differential pressure.

In this example, the flow diverter valves 216 are mounted in a mandrel 262 slidably positioned within a surrounding housing 264 having flow ports 266. The housing 264 is biased via a spring member 268 toward a position which generally aligns with flow ports 266. An upper end of the illustrated mandrel 262 engages the flapper type flow restrictor 260 when flow diverter valves 216 are aligned with flow ports 266. When the electric submersible pumping system 214 is turned off, flow restrictor 260 closes and fluid freely flows outwardly through flow diverter valves 216 and flow ports 266, as illustrated in FIG. 15. When the fluid flows outwardly through flow ports 266, it may be routed along bypass 64 past electric submersible pumping system 214. It should be noted that some embodiments may mount the flow diverter valves 216 in housing 264 or at another suitable housing/location depending on the design of the overall system.

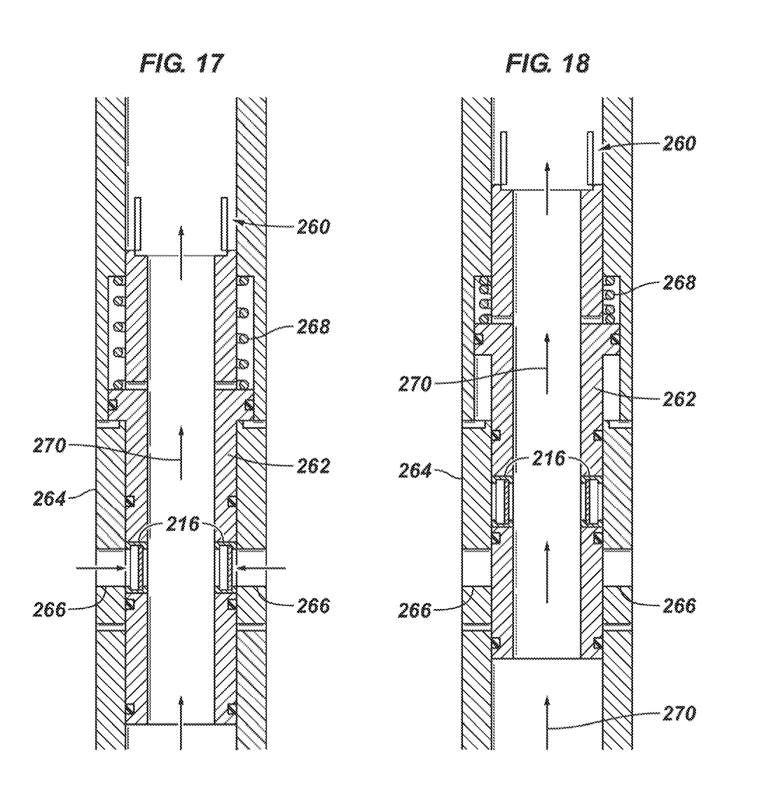

When the electric submersible pumping system 214 is turned on, the created pressure differential automatically opens flapper type flow restrictor 260, as illustrated in FIG. 17. This allows free flow of fluid upwardly through the tubing 258 to electric submersible pumping system 214, as indicated by arrows 270. The flow diverter valves 216 automatically close to prevent inflow of fluid through flow ports 266. In some embodiments, the mandrel 262 is designed to seal off flow ports 266 from inside to outside by lifting the mandrel 262 to isolate flow ports, as illustrated in FIG. 18. The electric submersible pumping system output pressure is higher than the electric submersible pumping system intake pressure when the electric submersible pumping system 214 is turned on. The differential pressure created by turning on the electric submersible pumping system 214 automatically opens the flow restrictor flapper segments 260 and closes the flow diverter valves 216. The mandrel 262 moves up and isolates flow ports 266 when the force created by differential pressure acting on the piston shoulder of the mandrel 262 overcomes the spring force. The upward movement of mandrel 262 shifts flow diverter valves 216 away from flow ports 266, and, in some embodiments, the upward movement also can be used to lock the flow restrictor 260 in an open flow position.

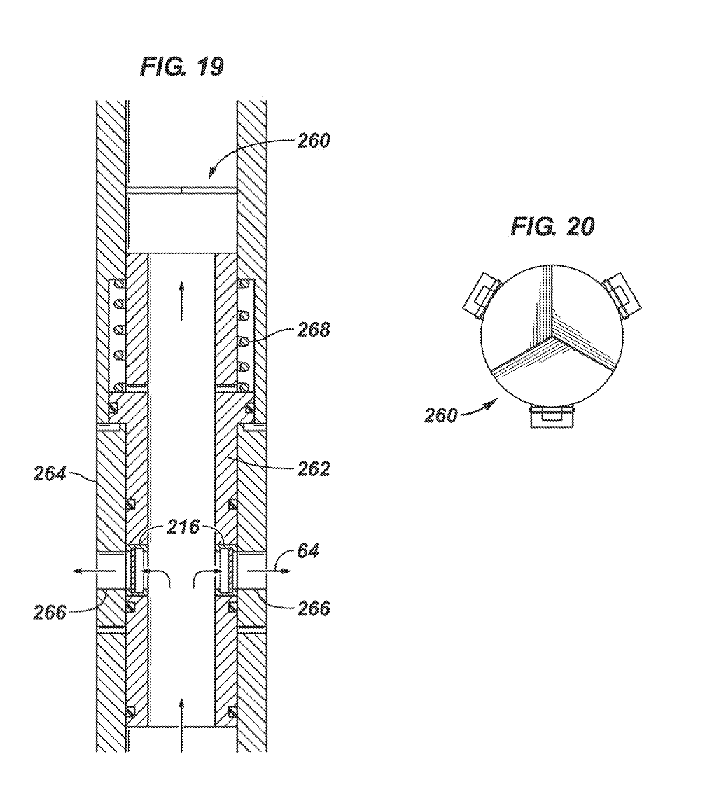

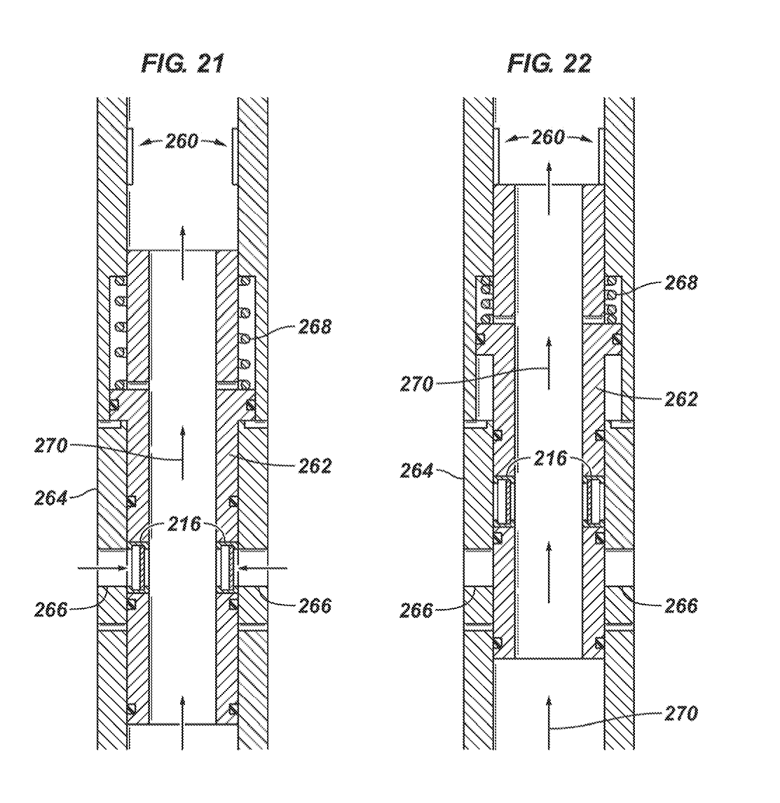

Referring generally to FIGS. 19-22, another embodiment is illustrated which is similar to the embodiment illustrated and described above with reference to FIGS. 15-18. In this latter embodiment, however, the upper end of mandrel 262 is positioned a spaced distance below flow restrictor 260 and does not engage the flapper type flow restrictor 260 when the electric submersible pumping system 214 is off (see FIGS. 19 and 20) or when the pumping system 214 is initially turned on (see FIG. 21). In this latter embodiment, the mandrel 262 may again be designed for movement within housing 264 so that flow diverter valves 216 may be shifted away from flow ports 266, as illustrated in FIG. 22. In some embodiments, the mandrel 262 may be designed such that shifting of the mandrel does not interfere with the automatic actuation of flow restrictor 260.

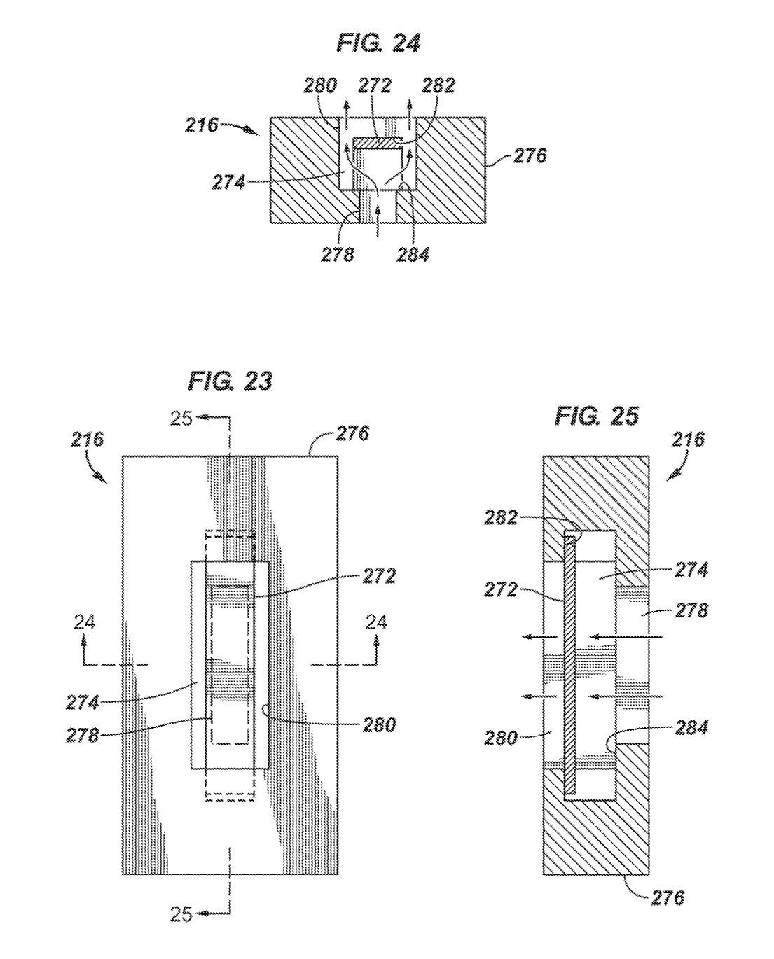

Although a variety of flow diverter valves 216 may be employed depending on the parameters of a given application, an example of one embodiment of the flow diverter valves 216 is illustrated in FIGS. 23-28. In this embodiment, each flow diverter valve 216 comprises a plate type floating flow restrictor which may be mounted, for example, in a wall of mandrel 262, in a wall of housing 264, or in another suitable location. The plate type floating flow restrictors are designed to allow free flow from inside mandrel 262 to an outside of the tool when the electric submersible pumping system 214 is off, as illustrated, in FIGS. 23-25.

As illustrated, each plate type floating flow restrictor 216 comprises a plate 272 which floats within a cavity 274 formed in a diverter valve housing 276. The diverter valve housing 276 has an inlet 278 extending into cavity 274 and an outlet 280. The outlet 280 may be interrupted by a plate stop or stops 282 positioned to stop or hold the plate 272 when the diverter valve 216 is in the free flow position illustrated in FIGS. 23-25. When the electric submersible pumping system 214 is turned off, fluid flowing within mandrel 262 moves plate 272 away from inlet 278 and against plate stops 282. This allows fluid to freely flow into inlet 278, through cavity 274, and out through outlet 280 so as to bypass electric submersible pumping system 214.

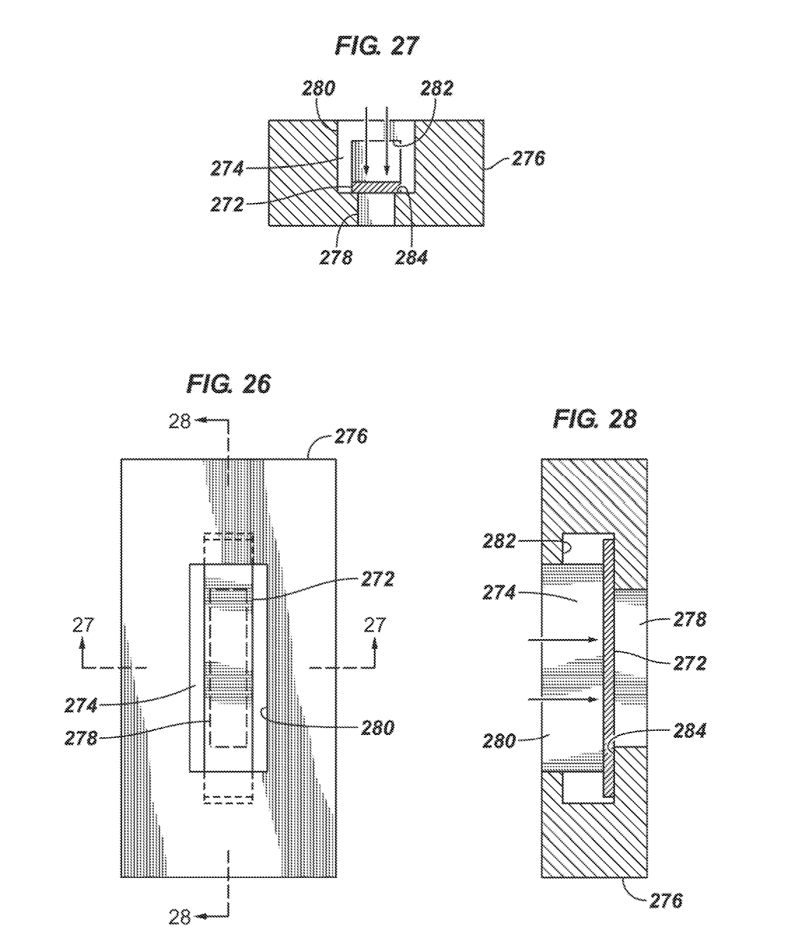

Once the electric submersible pumping system 214 is turned on, the pressure within mandrel 262 is less than the external pressure and this pressure differential moves plate 272 against a diverter valve seat 284, as illustrated in FIGS. 26-28. With plate 272 seated against the valve seat 284, flow through the diverter valve 216 is restricted which results in a higher outside to inside pressure differential. This pressure differential securely closes the diverter valve 216 and thus the flow ports 266. In some applications, the increased pressure differential is designed to shift the mandrel 262 against spring 268 to move the diverter valves 216 away from the flow ports 266, as illustrated in FIGS. 18 and 22. It should be noted, however, other types of flow diverter valves may be used in a variety of the embodiments discussed above, including ball type flow diverter valves, flapper type diverter valves, and other suitable flow diverter valves 216.

Depending on the flow control application, the embodiments described herein may be used to control flow and to provide bypass capability in a variety of flow systems, including well related flow systems and non-well related flow systems. In well related flow control systems, the well system may comprise many types of components and arrangements of components. Additionally, the flow bypass mechanisms may be used with a variety of devices and systems, including in-line barrier valves, e.g. ball valves and/or flapper valves, electric submersible pumping systems, or other devices that may utilize flow circumvention in certain situations. The specific type of flow bypass mechanisms, valves, port blocking members, indexers, and other components may be constructed in various designs and configurations depending on the parameters of a given well related application or other type of application.

Although a few embodiments of the system and methodology have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. A flow control system for use in a wellbore, comprising:
a well system comprising:
a flow control assembly;
a bypass positioned to route fluid flow around the flow control assembly within the well system; and
a flow bypass mechanism located along the bypass and positioned to selectively block flow along the bypass, the flow bypass mechanism being selectively displaceable to open the bypass for allowing fluid flow past the flow control assembly.

2. The flow control system as recited in claim 1, wherein the flow control assembly comprises an in-line barrier valve in the form of a ball valve.

3. The flow control system as recited in claim 1, wherein the flow control assembly comprises an in-line barrier valve in the form of a flapper valve.

4. The flow control system as recited in claim 1, wherein the flow control assembly comprises an electric submersible pumping system.

5. The flow control system as recited in claim 1, wherein the flow bypass mechanism comprises an indexer coupled to a port blocking member which is selectively movable by the indexer to allow flow through a plurality of bypass ports.

6. The flow control system as recited in claim 1, wherein the flow bypass mechanism comprises a plurality of diverter valves.

7. The flow control system as recited in claim 1, wherein the flow bypass mechanism is located on an in-line barrier valve.

8. A method of controlling flow in a well system, comprising:
positioning a flow control assembly in a downhole well system;
establishing a bypass around the flow control assembly;
controlling flow through the bypass with a flow bypass mechanism; and
operating the flow bypass mechanism interventionless.

9. The method as recited in claim 8, wherein positioning the flow control assembly comprises positioning an in-line barrier valve in the downhole well system.

10. The method as recited in claim 8, wherein positioning the flow control assembly comprises positioning an electric submersible pumping system in the downhole well system.

11. The method as recited in claim 10, wherein controlling comprises controlling flow with an auto flow diverter valve positioned to direct flow through the bypass and around the electric submersible pumping system.

12. The method as recited in claim 8, wherein controlling comprises controlling flow with an indexer coupled to a port blocking member.

13. The method as recited in claim 8, wherein controlling comprises controlling flow with a shearable mechanism.

14. The method as recited in claim 8, wherein operating the flow bypass mechanism interventionless comprises operating the flow bypass mechanism with a pressure differential.

15. The method as recited in claim 8, wherein operating the flow bypass mechanism interventionless comprises operating the flow bypass mechanism with a series of pressure pulses.

16. The method as recited in claim 8, wherein operating the flow bypass mechanism interventionless comprises operating the flow bypass mechanism with an absolute pressure application.

17. A method of controlling flow, comprising:
placing an in-line barrier valve along a flow passage;
routing a bypass past the in-line barrier valve;
locating a flow bypass mechanism to control flow along the bypass; and
utilizing interventionless operation to actuate the flow bypass mechanism so as to allow flow through the bypass while the in-line barrier valve is closed.

18. The method as recited in claim 17, wherein placing comprises placing the in-line barrier valve in a downhole well system.

19. The method as recited in claim 17, wherein locating comprises locating the flow bypass mechanism in the form of an indexer coupled to a port blocking member.

20. The method as recited in claim 17, wherein utilizing interventionless operation comprises applying pressure cycles.
